(19) United States
(12) Patent Application Publication
(10) Pub. No.: US 2016/0350563 A1
(43) Pub. Date: Dec. 1, 2016

(54) ARRANGEMENT FOR AND METHOD OF SWITCHING BETWEEN HANDS-FREE AND HANDHELD MODES OF OPERATION IN AN IMAGING READER

(71) Applicant: SYMBOL TECHNOLOGIES, LLC, Lincolnshire, IL (US)

(72) Inventors: DAVID C. YE, BALDWIN, NY (US); CHRISTOPHER P. KLICPERA, WESTBURY, NY (US); ARTUR K. KASPEREK, GLENDALE, NY (US)

(21) Appl. No.: 14/723,705

(22) Filed: May 28, 2015

(51) Int. Cl. G06K 7/10

(52) U.S. Cl. CPC G06K 7/109; G06K 7/10732

(57) ABSTRACT

An imaging reader reads targets by image capture in both handheld and hands-free modes of operation. A controller automatically switches from the hands-free mode to the handheld mode when a touch sensor detects that a user is holding the housing.

### BACKGROUND OF THE INVENTION

The present disclosure relates generally to an arrangement for, and a method of, switching between hands-free and handheld modes of operation in an imaging reader, and, more particularly, to improving reading performance of the reader.

Imaging readers, each having a solid-state imager or image sensor, analogous to those conventionally used in consumer digital cameras, have been used, in both handheld and/or hands-free modes of operation, and in both corded and cordless configurations, to electro-optically read targets, such as one-dimensional bar code symbols, particularly of the Universal Product Code (UPC) type, and two-dimensional bar code symbols, such as PDF417 and QR codes, and/or non-symbols or documents, such as prescriptions, labels, receipts, driver's licenses, employee badges, payment/loyalty cards, etc., in many different venues, such as at full-service or self-service, point-of-transaction, retail checkout systems operated by checkout clerks or customers, and located at supermarkets, warehouse clubs, department stores, and other kinds of retailers, as well as at many other types of businesses, for many years.

A known exemplary imaging reader includes a housing, either held in a user's hand by a user in the handheld mode, or supported on a support, such as a stand, a cradle, a docking station, or a support surface, in the hands-free mode, and a window supported by the housing. An energizable, illuminating light assembly in the housing uniformly illuminates the target. An aiming light assembly in the housing directs a visible aiming light beam to the target. An imaging assembly in the housing includes a solid-state imager (or image sensor or camera) with a sensor array of photocells or light sensors (also known as pixels), and an imaging lens assembly for capturing return light scattered and/or reflected from the illuminated target being imaged through the window over a field of view, and for projecting the return light onto the sensor array to initiate capture of an image of the illuminated target over a range of working distances in which the target can be read. Such an imager may include a one- or two-dimensional charge coupled device (CCD) or a complementary metal oxide semiconductor (CMOS) device and associated circuits for producing and processing electrical signals corresponding to a one- or two-dimensional array of pixel data over the field of view. These electrical signals are decoded and/or processed by a programmed microprocessor or controller into information related to the target being read, e.g., decoded data indicative of a symbol, or characters or marks indicative of text in a form field of a form, or into a picture indicative of a picture on the form. A trigger is manually actuated by the user to initiate reading in the handheld mode of operation. Sometimes, an object sensing assembly is employed to automatically initiate reading whenever a target enters the field of view in the hands-free mode of operation. At other times, the image sensor itself may be employed to detect entry of the target into the field of view.

In the hands-free mode, the user may slide or swipe the target past the window in either horizontal and/or vertical and/or diagonal directions in a “swipe” mode. Alternatively, the user may present the target to an approximate central region of the window in a “presentation” mode. The choice depends on the type of target, operator preference, or on the layout of a workstation in which the reader is used. In the handheld mode, the user holds the reader in his or her hand at a certain working distance from the target to be imaged and initially aims the reader at the target with the aid of the aiming light beam. The user may first lift the reader from a countertop or like support surface, or from a support, such as a stand, a cradle, or a docking station. Once reading is completed, the user may return the reader to the countertop, or to the support, to resume hands-free operation.

Although the known imaging readers are generally satisfactory for their intended purpose, one concern relates to the hands-free mode of operation, in which the imaging assembly is constantly attempting to read any target placed within its field of view, and the illuminating light assembly is constantly being energized to illuminate any such target, and the controller is constantly attempting to decode any such illuminated target. These operations, if allowed to continue in the handheld mode, consume extra electrical energy, generate excess heat, and reduce the working lifetimes of the reader's components. In addition, the illumination light is typically very bright and is pulsed, and many users, as well as nearby customers, find such bright, pulsed light annoying, especially when repeated during checkout at a retail venue.

Still another concern relates to the switchover from the hands-free mode to the handheld mode. As previously noted, in the hands-free mode, the reader is constantly attempting to read, illuminate and decode any target placed in front of its window. When the user removes the reader from the countertop or like support, the reader does not yet know that the user wishes to read a target in the handheld mode by actuating a trigger. Before the trigger is actuated, the reader may accidentally and erroneously read one or more targets that happened to be in its field of view, thereby degrading reader performance.

The art has proposed to detect the switchover to the handheld mode by placing an accelerometer in the housing to detect the housing's acceleration. However, the ability to sense the housing's acceleration is thwarted when the user is holding the housing very still, or is moving the housing at a constant velocity with no or little acceleration. The art has also proposed to detect the switchover to the handheld mode by adding a mechanical or magnetic switch to the housing, the switch being actuated when the reader is removed from a support. Yet, the switch introduces significant cost and complexity to the reader, and also provides an avenue for moisture, air, dust and like contaminants to enter the housing past the switch.

Accordingly, there is a need for an arrangement for, and a method of, reliably switching from the hands-free mode to the handheld mode of operation in an imaging reader to conserve electrical energy usage, reduce waste heat, prolong the working lifetime of the reader's components, reduce the annoyance of bright, pulsed illumination light, and prevent erroneous reading of targets, without relying on accelerometers or mechanical or magnetic switches.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of one embodiment of an imaging reader operative in a hands-free mode, for capturing images from targets to be electro-optically read in accordance with this disclosure.

FIG. 2 is a perspective view of the embodiment of the reader of FIG. 1 operative in a handheld mode.

FIG. 3 is a perspective view of another embodiment of an imaging reader operative in a hands-free mode, for capturing images from targets to be electro-optically read in accordance with this disclosure.

FIG. 4 is a perspective view of the embodiment of the reader of FIG. 3 operative in a handheld mode.

FIG. 5 is a schematic diagram of various components of the reader in either the embodiment of FIGS. 1-2 or the embodiment of FIGS. 3-4.

FIG. 6 is an enlarged, part-schematic, part-sectional view depicting the embodiment of the reader of FIG. 1 operated in the hands-free mode.

FIG. 7 is a flow chart depicting steps performed in accordance with the method of this disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An arrangement for reading a target by image capture, in accordance with one feature of this disclosure, includes a housing having a window and a manually-actuatable trigger. A touch sensor is supported by the housing, and detects a handheld mode of operation in which a user holds the housing and manually actuates the trigger during image capture, and a hands-free mode of operation in which the user does not hold the housing and does not manually actuate the trigger during image capture. Advantageously, the touch sensor is a capacitive sensor for sensing user hand capacitance when the user's hand touches the housing. An imaging assembly is supported by the housing and includes a solid-state imager, e.g., a CCD or a CMOS device, having an array of light sensors looking at a field of view that extends through the window to the target, and captures return light from the target to be read in both modes. A controller is operatively connected to the touch sensor and the imager, and controls the imager to capture return light from the target to be read without manually actuating the trigger in the hands-free mode, and to capture return light from the target to be read by manually actuating the trigger in the handheld mode. The controller automatically switches from the hands-free mode to the handheld mode when the touch sensor detects that the user is holding the housing.

In a preferred embodiment, an energizable, illuminating light assembly is supported by the housing, and illuminates the target. The controller energizes the illuminating light assembly to illuminate the target without manually actuating the trigger in the hands-free mode, and to illuminate the target by manually actuating the trigger in the handheld mode. Also, an energizable, aiming light assembly is supported by the housing, and generates an aiming light beam. The controller energizes the aiming light assembly to direct the aiming light beam at the target by manually actuating the trigger in the handheld mode. In addition, the controller processes the captured return light without manually actuating the trigger in the hands-free mode, and processes the captured return light by manually actuating the trigger in the handheld mode.

In accordance with another feature of this disclosure, a method of reading a target by image capture is performed by supporting a window and a manually-actuatable trigger on a housing; by detecting a handheld mode of operation in which a user holds the housing and manually actuates the trigger during image capture, and a hands-free mode of operation in which the user does not hold the housing and does not manually actuate the trigger during image capture; by capturing return light from the target to be read in both modes with a solid-state imager having an array of light sensors looking at a field of view that extends through the window to the target; by controlling the imager to capture return light from the target to be read without manually actuating the trigger in the hands-free mode, and to capture return light from the target to be read by manually actuating the trigger in the handheld mode; and by automatically switching from the hands-free mode to the handheld mode upon detection that the user is holding the housing.

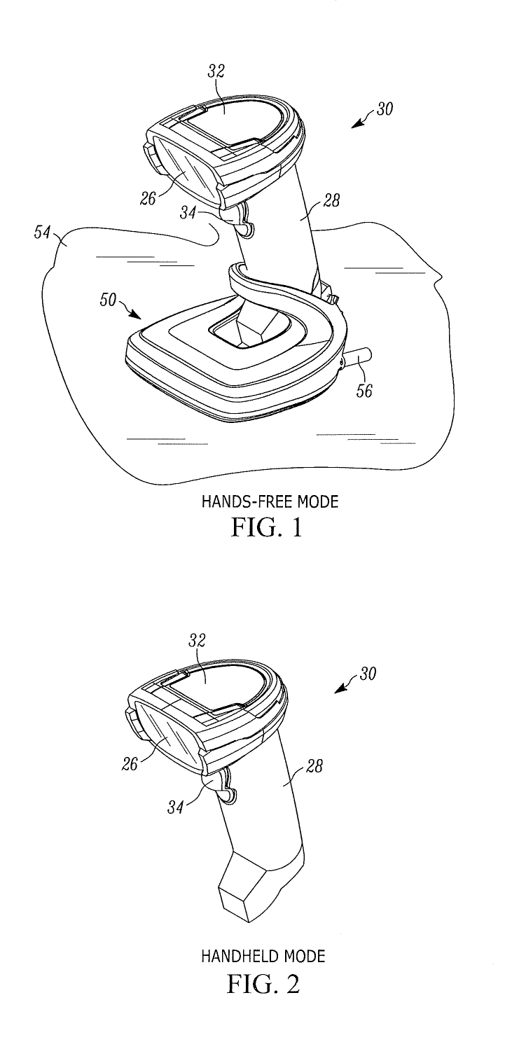

Turning now to FIGS. 1-2 of the drawings, reference numeral 30 generally identifies one embodiment of an electro-optical, imaging reader that is ergonomically advantageously configured as a gun-shaped housing having an upper barrel or body 32 and a lower handle 28 extending rearwardly away from the body 32. Housings of other configurations could also be employed. A light-transmissive window 26 is located adjacent a front or nose of the body 32. In the embodiment of FIGS. 1-2, the reader 30 is cordless and is removable from a support or presentation cradle 50 that rests on a support surface 54, such as a countertop or a tabletop. The reader 30 is either mounted, preferably in a forwardly-tilted orientation, in the cradle 50 that rests on the support surface 54, and used in a hands-free mode of operation, as shown in FIG. 1, in which symbol/document targets are presented in a range of working distances relative to the window 26 for reading, or the reader 30 is removed and lifted from the cradle 50, and held by the handle 28 in an operator's hand, and used in a handheld mode of operation, as shown in FIG. 2, in which a trigger 34 is manually actuated and depressed to initiate reading of symbol/document targets in a range of working distances relative to the window 26. A cable 56 is connected to the cradle 50 to deliver electrical power to the cradle 50 and to support bidirectional communications between the docked reader 30 and a remote host (not illustrated).

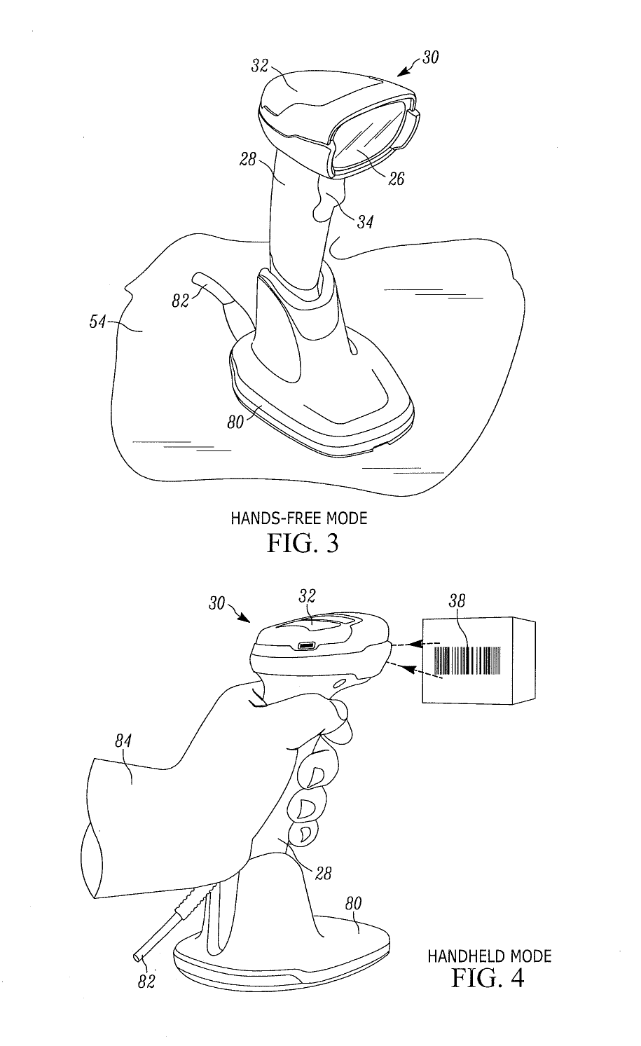

Another embodiment, and currently the preferred embodiment of this disclosure, of the electro-optical, imaging reader 30 is shown in FIGS. 3-4, and like numerals have been used to identify like parts. Thus, in FIGS. 3-4, the reader 30 again has a body 32, a handle 28, a window 26, and a trigger 34, as described above. In contrast to the embodiment of FIGS. 1-2, the reader 30 of FIGS. 3-4 is not removable, but is connected to, a support or stand 80 to which a cable 82 is connected to deliver electrical power to the reader 30 and to support bidirectional communications between the reader 30 and a remote host (not illustrated). The reader 30 of FIGS. 3-4, together with its stand 80, are either jointly mounted, preferably in a forwardly-tilted orientation, on the support surface 54, and used in a hands-free mode of operation, as shown in FIG. 3, in which symbol/document targets are presented in a range of working distances relative to the window 26 for reading, or the reader 30 of FIGS. 3-4, together with its stand 80, are jointly lifted as a unit off the support surface 54, and held by the handle 28 in an operator's hand 84, and used in a handheld mode of operation, as shown in FIG. 4, in which the trigger 34 is manually actuated and depressed to initiate reading of symbol/document targets, such as target 38, in a range of working distances relative to the window 26.

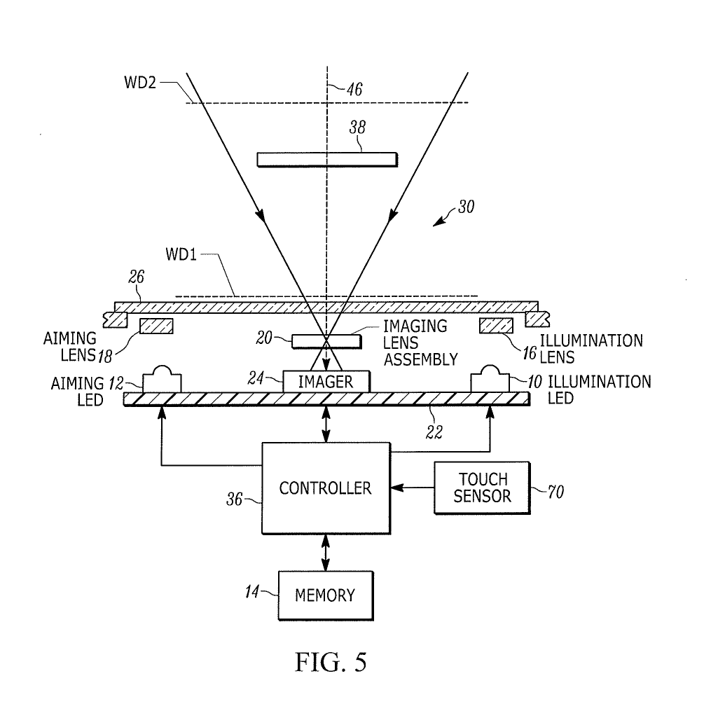

For either reader embodiment, as schematically shown in FIG. 5, an imaging assembly includes an imager 24 mounted on a printed circuit board (PCB) 22 in the reader 30. The imager 24 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imaging lens assembly 20 over a field of view along an imaging axis 46 through the window 26 in either mode of operation. The return light is scattered and/or reflected from the target 38 over the field of view. The imaging lens assembly 20 is operative for focusing the return light onto the array of image sensors to enable the target 38 to be read. The target 38 may be located anywhere in a working range of distances between a close-in working distance (WD1) and a far-out working distance (WD2). In a preferred embodiment, WD1 is about one-half inch from the window 26, and WD2 is about thirty inches from the window 26.

An illuminating light assembly is also mounted in the imaging reader 30. The illuminating light assembly includes an illumination light source, e.g., at least one light emitting diode (LED) 10 and at least one illumination lens 16, and preferably a plurality of illumination LEDs and illumination lenses, configured to generate a substantially uniform distributed illumination pattern of illumination light on and along the target 38 to be read by image capture. At least part of the scattered and/or reflected return light is derived from the illumination pattern of light on and along the target 38.

An aiming light assembly is also mounted in the imaging reader 30 and preferably includes an aiming light source 12, e.g., one or more aiming LEDs, and an aiming lens 18 for generating and directing a visible aiming light beam away from the reader 30 onto the symbol 38 in the handheld mode. The aiming light beam 50 has a cross-section with a pattern, for example, a generally circular spot or cross-hairs for placement at the center of the symbol 38, or a line for placement across the symbol 38, or a set of framing lines to bound the field of view, to assist an operator in visually locating the symbol 38 within the field of view prior to image capture.

As also shown in FIG. 5, the imager 24, the illumination LED 10, and the aiming LED 12 are operatively connected to a controller or programmed microprocessor 36 operative for controlling the operation of these components. A memory 14 is connected and accessible to the controller 36. Preferably, the microprocessor is the same as the one used for processing the captured return light from the illuminated target 38 to obtain data related to the target 38.

In the hands-free mode of operation, the controller 36 may either be free-running and continuously or intermittently send a command signal to energize the illumination LED 10 for a short exposure time period, say 500 microseconds or less, and energizes and exposes the imager 24 to collect the return light, e.g., illumination light and/or ambient light, from the target 38 only during said exposure time period. Alternatively, the imager 24 or an object sensor may be employed to detect entry of the target 38 into the field of view and, in response to such target entry detection, the controller 36 sends the aforementioned command signal. In the hands-free mode, the imaging assembly 20, 24 is constantly attempting to read any target 38 placed within its field of view, and the illuminating light assembly 10, 16 is constantly being energized to illuminate any such target 38, and the controller 36 is constantly attempting to decode any such illuminated target 38. These operations, if allowed to continue in the handheld mode, consume extra electrical energy, generate excess heat, and reduce the working lifetimes of the components of the reader 30. In addition, the illumination light is typically very bright and is pulsed, and many users, as well as nearby customers, find such bright, pulsed light annoying, especially when repeated during checkout at a retail venue.

In the handheld mode of operation, in response to actuation of the trigger 34, the controller 36 sends a command signal to energize the aiming LED 12, and to energize the illumination LED 10, for a short exposure time period, say 500 microseconds or less, and energizes and exposes the imager 24 to collect the return light, e.g., illumination light and/or ambient light, from the target 38 only during said exposure time period. In the handheld mode, there is no constant attempt to illuminate, capture return light from, or process or decode, any target 38, thereby conserving electrical energy usage, reducing waste heat, prolonging the working lifetime of the reader's components, and reducing the annoyance of bright, pulsed illumination light. In the handheld mode, most, if not all, of the components of the reader 30 are activated only in response to actuation of the trigger 34.

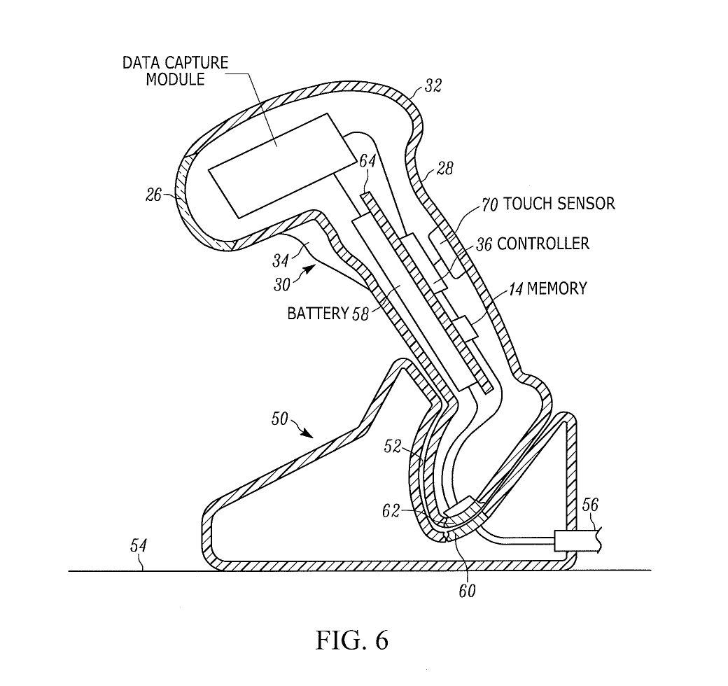

Turning now to FIG. 6, the support 50 is illustrated by a docking or base station or cradle having a compartment 52 for receiving and holding the reader 30 in a hands-free mode when the reader 30 is not handheld. In the hands-free mode, the docked reader operates as a workstation to which targets 38 to be read can be brought in front of the window 26 for image capture, as described above. The cable 56 includes power conductors for supplying electrical power to recharge a battery 58 in the cordless reader 30, as well as data conductors for transmitting decoded data, control data, update data, etc. between the reader 30 and a remote host (not illustrated). Electrical contacts 60 on the cradle 50 mate with electrical contacts 62 on the reader 30 to enable mutual electrical communication in the hands-free, docked state. The controller 36 and the memory 14 are mounted on a printed circuit board (PCB) 64 mounted in the handle 28, and are connected to a data capture module, which comprises the aforementioned imaging assembly, the aforementioned illuminating assembly, and the aforementioned aiming assembly, all as described above in connection with FIG. 5. The data capture module is mounted in the body 32.

As previously noted, in the hands-free mode of FIG. 6, the reader 30 is constantly attempting to read, illuminate and decode any target 38 placed in front of its window 26. When the user removes the reader 30 from the cradle 50, the reader 30 does not yet know that the user wishes to read a target in the handheld mode by actuating the trigger 34. Before the trigger 34 is actuated, the reader 30 may accidentally and erroneously read one or more targets 38 that happened to be in its field of view, thereby degrading reader performance.

In accordance with this disclosure, and as illustrated in FIGS. 5-6, a touch sensor 70 is mounted on either embodiment of the reader 30, preferably on the handle 28. The touch sensor 70 is operative for detecting the handheld mode of operation in which the user holds the cordless reader 30, either by itself (FIG. 2), or jointly with the corded stand 80 (FIG. 4), and manually actuates the trigger 34 during image capture, and for detecting the hands-free mode of operation in which the user does not hold the reader 30 and does not manually actuate the trigger 34 during image capture. The controller 36 automatically switches from the triggerless, hands-free mode to the triggered, handheld mode when the touch sensor 70 detects that the user is holding the reader 30, and preferably when the user is touching the handle 38. The triggerless, hands-free mode is the default mode.

Advantageously, the touch sensor 70 is a capacitive sensor for sensing user hand capacitance when the user's hand touches the housing of either embodiment of the reader 30. Although the touch sensor 70 has been shown as being mounted on the handle 38, it could be located anywhere on of either embodiment of the reader 30, especially on the trigger 34. Rather than employing a capacitive sensor, the sensor 70 could also be a pressure sensor or a heat sensor.

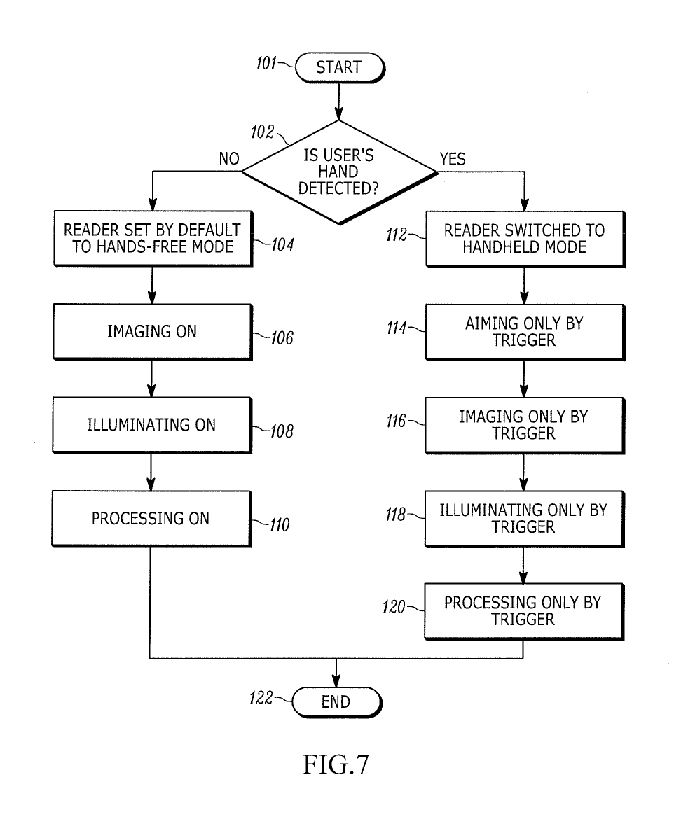

Turning now to the flow chart of FIG. 7, beginning a reading session at start step 101, the reader 30 is initially set by default to the hands-free mode (step 104), in which the imaging assembly is energized (step 106), the illuminating assembly is energized (step 108), and the controller 36 performs processing on the illuminated target 38 (step 110). Once the user's hand 84 is detected in step 102, then the controller 36 automatically switches the reader 30 to the handheld mode (step 112), in which the aiming assembly is energized only in response to trigger actuation (step 114), the imaging assembly is energized only in response to trigger actuation (step 116), the illuminating assembly is energized only in response to trigger actuation (step 118), and the controller 36 performs processing on the illuminated target 38 only in response to trigger actuation (step 120). The reading session stops at end step 122.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for reading a target by image capture, comprising:
a housing having a window and a manually-actuatable trigger;
a touch sensor supported by the housing, and operative for detecting a handheld mode of operation in which a user holds the housing and manually actuates the trigger during image capture, and a hands-free mode of operation in which the user does not hold the housing and does not manually actuate the trigger during image capture;
an imaging assembly supported by the housing and including a solid-state imager having an array of light sensors looking at a field of view that extends through the window to the target, and operative for capturing return light from the target to be read in both modes; and
a controller operatively connected to the touch sensor and the imager, and operative for controlling the imager to capture return light from the target to be read without manually actuating the trigger in the hands-free mode, and to capture return light from the target to be read by manually actuating the trigger in the handheld mode, and for automatically switching from the hands-free mode to the handheld mode when the touch sensor detects that the user is holding the housing.

2. The arrangement of claim 1, and an energizable, illuminating light assembly supported by the housing, and operative for illuminating the target, and wherein the controller is operatively connected to, and energizes, the illuminating light assembly to illuminate the target without manually actuating the trigger in the hands-free mode, and to illuminate the target by manually actuating the trigger in the handheld mode.

3. The arrangement of claim 1, and an energizable, aiming light assembly supported by the housing, and operative for generating an aiming light beam, and wherein the controller is operatively connected to, and energizes, the aiming light assembly to direct the aiming light beam at the target by manually actuating the trigger in the handheld mode.

4. The arrangement of claim 1, wherein the controller processes the captured return light without manually actuating the trigger in the hands-free mode, and processes the captured return light by manually actuating the trigger in the handheld mode.

5. The arrangement of claim 1, wherein the touch sensor is a capacitive sensor for sensing user hand capacitance when the user's hand touches the housing.

6. The arrangement of claim 1, wherein the housing has a handle, and wherein the touch sensor is mounted on the handle.

7. The arrangement of claim 1, and a corded docking station for supporting the housing in the hands-free mode, and wherein the housing is cordless and is removed from the docking station in the handheld mode.

8. The arrangement of claim 1, and a corded stand for supporting the housing in the hands-free mode, and wherein the housing is connected to the stand and is jointly movable with the stand in the handheld mode.

9. An arrangement for reading a target by image capture, comprising:
a housing having a window, a handle, and a manually-actuatable trigger on the handle;
a touch sensor supported by the handle, and operative for detecting a handheld mode of operation in which a user touches the handle and manually actuates the trigger during image capture, and a hands-free mode of operation in which the user does not touch the handle and does not manually actuate the trigger during image capture;
an imaging assembly supported by the housing and including a solid-state imager having an array of light sensors looking at a field of view that extends through the window to the target, and operative for capturing return light from the target to be read in both modes; and
a controller operatively connected to the touch sensor and the imager, and operative for controlling the imager to capture return light from the target to be read without manually actuating the trigger in the hands-free mode, and to capture return light from the target to be read by manually actuating the trigger in the handheld mode, and for automatically switching from the hands-free mode to the handheld mode when the touch sensor detects that the user is touching the handle.

10. The arrangement of claim 9, and an energizable, illuminating light assembly supported by the housing, and operative for illuminating the target, and wherein the controller is operatively connected to, and energizes, the illuminating light assembly to illuminate the target without manually actuating the trigger in the hands-free mode, and to illuminate the target by manually actuating the trigger in the handheld mode.

11. The arrangement of claim 9, and an energizable, aiming light assembly supported by the housing, and operative for generating an aiming light beam, and wherein the controller is operatively connected to, and energizes, the aiming light assembly to direct the aiming light beam at the target by manually actuating the trigger in the handheld mode.

12. The arrangement of claim 9, wherein the controller processes the captured return light without manually actuating the trigger in the hands-free mode, and processes the captured return light by manually actuating the trigger in the handheld mode.

13. The arrangement of claim 9, wherein the touch sensor is a capacitive sensor for sensing user hand capacitance when the user's hand touches the handle.

14. A method of reading a target by image capture, comprising:
supporting a window and a manually-actuatable trigger on a housing;
detecting a handheld mode of operation in which a user holds the housing and manually actuates the trigger during image capture, and a hands-free mode of operation in which the user does not hold the housing and does not manually actuate the trigger during image capture;
capturing return light from the target to be read in both modes with a solid-state imager having an array of light sensors looking at a field of view that extends through the window to the target;
controlling the imager to capture return light from the target to be read without manually actuating the trigger in the hands-free mode, and to capture return light from the target to be read by manually actuating the trigger in the handheld mode; and
automatically switching from the hands-free mode to the handheld mode upon detection that the user is holding the housing.

15. The method of claim 14, and illuminating the target without manually actuating the trigger in the hands-free mode, and illuminating the target by manually actuating the trigger in the handheld mode.

16. The method of claim 14, and directing an aiming light beam at the target by manually actuating the trigger in the handheld mode.

17. The method of claim 14, and processing the captured return light without manually actuating the trigger in the hands-free mode, and processing the captured return light by manually actuating the trigger in the handheld mode.

18. The method of claim 14, wherein the detecting is performed by sensing user hand capacitance when the user's hand touches the housing.

19. The method of claim 14, and configuring the housing with a handle, and wherein the detecting is performed by mounting a touch sensor on the handle.
